(19) United States
(12) Patent Application Publication
(10) Pub. No.: US 2004/0243830 A1
(43) Pub. Date: Dec. 2, 2004

(54) Method and system of secret communication

(76) Inventors: Vladimir Kutcherov, Stockholm (SE); Alexei Potapkin, Moscow (RU)

Correspondence Address: Rolf Fasth, Fasth Law Offices, 629 E Boca Raton Road, Phoenix, AZ, 85022, US

(21) Appl. No.: 10/489,548

(22) PCT Filed: Sep. 9, 2002
(86) PCT No.: PCT/SE02/01623

(30) Foreign Application Priority Data
Sep. 20, 2001 (US) 60323640

(51) Int. Cl. H04L 9/32; G06F 11/30; G06F 12/14

(52) U.S. Cl. 713/200

(57) ABSTRACT

The method is for a secret communication between a transmitting unit and a receiving unit. The first time any message is sent from the transmitting unit (1) to the receiving unit (2), the units are synchronized, The transmitting unit (1) generates a public key (16) and a first security key (17a). A message (15) is encrypted using the public key and the first security key (17a). The encrypted message (18) and the public key (16) are sent via a transmitting medium (3). The first security key (17a) is not sent to the receiving unit (2). Upon receipt, the receiving unit generates a second security key (17b) that is identical to the first security key (17a). The receiving unit decrypts the message (18) to the readable message (15) using the public key (16) and the second security key (17b).

### TECHNICAL FIELD

The invention relates to a method and system to provide confidentiality of messages that are sent via communication lines.

### SUMMARY AND BACKGROUND OF THE INVENTION

There exists a method of secret communication based on encrypted messages that use a public key which includes a generation of digital signals of encrypted B-messages from the digital signal of initial A-messages with the help of the public key according to the formula B=A mod m, wherein the parameter (m)=(p) (q) and where (p) and (q) are secret prime numbers. Entities (e) and (m) form the public key, transmit encrypted message via communication line and decipher the received encrypted message with the help of the security key. A number, reciprocally prime to the number (p−1), is chosen as the public index and the security index (S) is chosen according to the relationship (S e) mod (p−1)=1. The deciphering is performed by obtaining the remainder (B) of the received encrypted B-message according to the formula B=B mod p, and by obtaining the decrypted A-message following the formula A=B mod p wherein the parameters (s) and (p) are forming the security key. The security key in this method is known beforehand and can get in the hands of unauthorized persons who may gain access to the transmitted messages. Hence, this method has not sufficient cryptal endurance.

U.S. Pat. No. 5,787,173, entitled “Equipment and method for establishing cryptographic connection between system's elements” includes the steps of generating public and security keys, sending of public keys via communication lines, and a secure transmission of security cipher/decipher keys from one operation unit to another. The key generation is performed by a special device. Security and public keys, followed by authentication certificates, are recorded to read-only memory of secret chips sitting in all operation units of the system, after which this memory is ready for use i.e. for encryption, message transmission and reception by operation unit, message deciphering at the receiving unit. The system of secret communication, employing the described way of establishing secure communication, is made up of operation units such as receiving and transmitting units. Each unit is equipped by a secret chip containing encrypting/decrypting keys stored in the memory once and for all.

The drawback of this way of establishing the cryptographic communication lies is the fact that security keys and secret chips may get lost or become known to a third party after which the system will lose its cryptic security and may become accessible for unauthorized persons.

One object of the present invention is to provide increased encrypting durability of communication and excluding the possibility of unauthorized access to transmitted information. Additionally, the system and use of the present invention are simple and reliable.

This task may performed by the secret communication method including generation of the digital signal of encrypted message from the digital signal of initial message by using public and security keys on the transmitting unit. An encrypted message is sent via a communication line that is received, decrypted to form the initial message at the receiving unit. The method may take advantage of the fact that during each communication session the public key is transmitted, new identical security keys are generated at the receiving and transmitting units. Then the digital encrypted message is generated from the digital signal of initial message by public and security keys, transmitted via a communication line, received and deciphered with the help of a security key obtained at the receiving unit.

The system of present invention contains both transmitting and receiving operation units that are connected by a transmission medium and equipped by means of generating, encrypting and transmitting encrypted messages, and by means of receiving, decrypting and generating an initial message by using public and security keys. The transmitting and receiving operation units are equipped with generators of identical security keys that may be used to generate new keys for each communication session.

Such method and system of secret communication provides a qualitatively new degree of information security because the security key cannot be lost or passed over to third person. The user's access to protected resources is simplified. In particular, the method is for a secret communication between a transmitting unit and a receiving unit. The first time any message is sent from the transmitting unit 1 to the receiving unit 2, the units are synchronized. The transmitting unit 1 generates a public key 16 and a first security key 17a. A message 15 is encrypted using the public key and the first security key 17a. The encrypted message 18 and the public key 16 are sent via a transmitting medium 3. The first security key 17a is not sent to the receiving unit 2. Upon receipt, the receiving unit generates a second security key 17b that is identical to the first security key 17a. The receiving unit decrypts the message 18 to the message 15 using the public key 16 and the second security key 17b.

### BRIEF DESCRIPTION OF THE DRAWINGS

FIG. 1 demonstrates a flow-chart of an implementation system of the present invention; and

FIG. 2 shows a method of forming a security key of the present invention.

### DETAILED DESCRIPTION

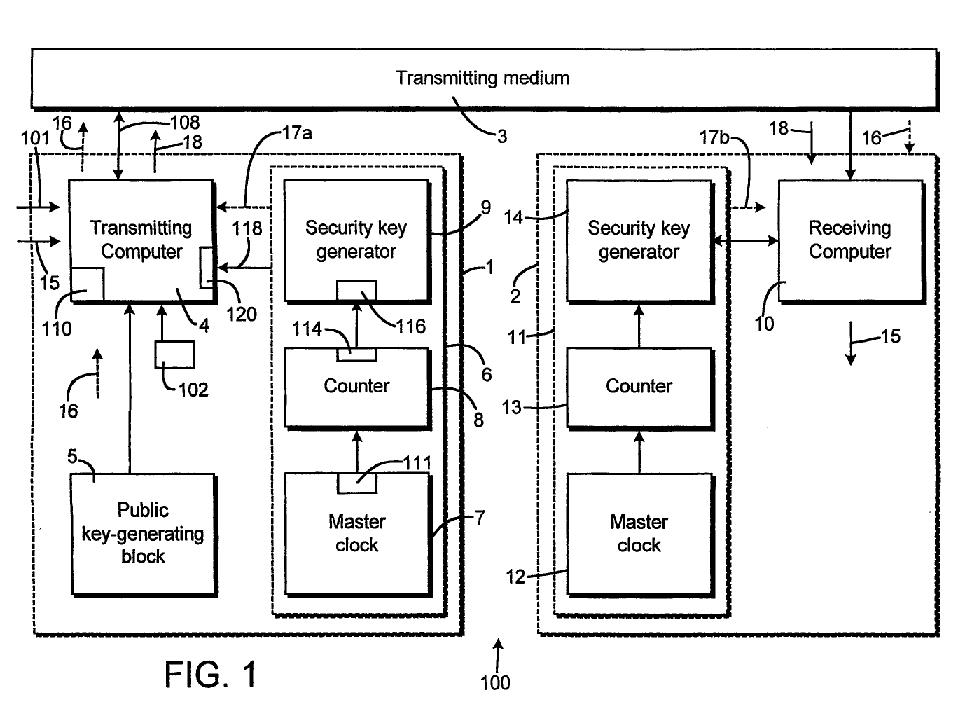

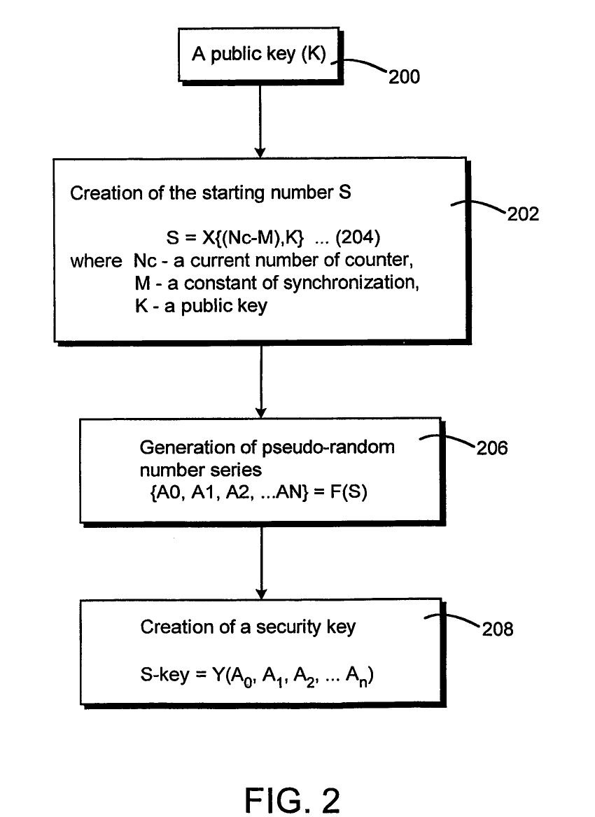

With reference to FIGS. 1-2, the method of secret communication, according to the present invention, may be implemented in a system containing transmitting and receiving operation units that are connected via signal transmission medium in the following way:

1. The transmitting and receiving operation units are switched on and in communication via a transmission medium such as a cable or the Internet;

2. The operation units are synchronized by, for example, simultaneously memorizing the synchronization constant of the transmitting and receiving units before the first communication ever between the two units is transmitted. This synchronization step is not necessary for future messages once the units have been synchronized.

3. The initial message is put in to the transmitting operation unit;

4. The public key is generated and put in to the transmitting operation unit;

5. The public key is sent via a transmission medium;

6. New identical security keys are generated for each connection session at the transmitting and receiving operation units using identical generators of pseudo-random digital series;

7. An initial digital message is encrypted in the transmitting operation unit by using the public and security keys;

8. An encrypted message is sent via the transmission medium to the receiving operation unit; and

9. The received message is decrypted in the receiving operation device by using the public key and the security key generated by the receiving unit. In general, the system 100 for implementing the method may include the steps of connecting the transmitting and receiving operation units by a transmission medium. The transmitting operation unit is equipped with means for generating, encrypting and transmitting encrypted messages and the receiving operation unit is equipped with means for receiving, decrypting and generating the initial message by corresponding usage of public and security keys. The system 100 may also be equipped with means for generating or putting in the public key and with means for generating security keys. The means for creating the security keys on the transmitting and receiving operation units may be designed as identical generators of pseudo-random digital series that generate new identical security keys during each communication session. The means for creating the security keys may be designed as programmable micro-controllers which output is connected to the operation units. The input unit may be connected with an output unit of the counter that is connected with a master clock. Any known digital device, that provides the function of a specific system, may be used as means for forming, encrypting and transmitting the initial digital message, for receiving and decrypting the received signal and for generating or putting in the public key.

With reference to FIG. 1, the system 100 may be used for secret communication in computer networks that may include a transmitting unit 1 and a receiving unit 2 that are connected to one another via a transmission medium 3. The transmission medium 3 for a computer network may be a network cable or an Internet connection or any other suitable transmission media. An important feature of the system 100 is that no security key is passed from the transmitting unit 1 to the receiving unit 2 and that the units 1, 2 create the same security key since the master clocks of each unit 1, 2 have been synchronized. Because the security keys are created by both the transmitting and receiving units, each communication or message sent between the units may use a different security keys because the master clocks have advanced and the starting numbers change with time. Preferably, the transmitting unit 1 may include a transmitting computer 4 that is connected to a public key generating block 5 and a security key generating block 6. A two-way communication line 108 connects the computer 4 to the transmitting medium 3. The block 6 for generating the security key may be connected with the transmitting computer 4 via its system bus. The computer 4 has an input device 102 that may be a keyboard or some storage media on magnetic and optical disks. For the two-way communication with the transmission medium 3, a network card 110 or a modem may be used in the computer 4. A fingerprint scanner or a keyboard may serve as the public key generating device 5 for putting in the public key to the computer 4.

Preferably, the block 6 has a master clock 7, with a frequency divider, connected by its output unit 111 to an input 112 of a counter 8. An output 114 of the counter 8 may be connected to an input 116 of a security key generator 9. It should be understood, that the clock 7 could be any device that generates numbers or letters. Additionally, the security key generator 9 is connected via a two-way connection 118 to a system bus 120 of the computer 4.

The public key in the system 100 may be a number obtained as a result of transforming the image of fingerprints taking into account the finger's temperature and micro-tremor. The public key-generating block 5 connected to the computer 4 may, for example, be a fingerprint scanner.

In the most simple case, the public key-generating block 5 may be absent and a random array of symbols may be entered by the user from the keyboard 102 connected to the computer 4 so that the random array serves as the public key. The security key generator 9 may operate with (m+n) input states and (s) output states, where (m) may be the capacity of the counter 8, (n) is the number of bit positions in the public key, and (s) is the number of positions in the S-key. As described in detail below, a security key generator 14 of the receiving unit is, preferably, identical to the generator 9.

The generator may be used to generate pseudo-random number series. It may be performed in a specialized micro-controller. The program, that operates in the micro-controller to generate pseudo-random number series is, preferably, stored in a read-only memory of the micro-controller during the generation of the pseudo-random number series. The program chip may be designed to perform only this specific function and nothing else. The word pseudo-random may mean that the same output results are generated when the same input is used.

The security key may be the logical sum of the public key and the number that corresponds to the current output state of the counters 8 and 13. The method of generating the random series may be designed as follows.

The output value of a random series generator {A0, A1, A2 . . . AN} may be obtained from the starting input value (S) by calculating the value of the pseudo-random functions as shown in equations (1) and (2):

{A0, A1, A2 . . . AN}=X(S); and Equation (1)

S=F{NC−M), K} Equation (2)

wherein (S) is the starting number of a current number of a counter (NC), a synchronization constant (M) and the parameter (K) is a public key. The pseudo-random function (X) may be described as shown in equation (3):

X(S)=A^{x}+C(mod D)

wherein the constants (A), (C) and (D) preferably satisfies the following conditions, as outline in equation (4) below:

D=2^{T} Equation (4)

wherein the parameter (T) is the word length of micro-controller. The constant (A) constant should, preferably, satisfy three conditions simultaneously, as shown in equations (5), (6) and (7) below:

A>D/100 Equation (5)

A<D−SQRT(D) Equation (6)

A(MOD 8)=5 Equation (7)

wherein the constant (C) may be an integer and an odd number.

The receiving device 2 may have a receiving computer 10 and a security key generating block 11. The block 11 may contain a master clock 12, a counter 13 and a security key generator 14. As indicated above, the generator 14 may be identical to the security key generator 9 connected to the transmitting computer 4. On the whole, the design of the receiving device 2 and its functions are, preferably, substantially identical to the transmitting device 1. However, one difference is that the transmitting computer 4 encrypts and transmits the message while the receiving computer 10 receives and decrypts the same message.

If the system 100 is designed for a two-way communication, the receiving and transmitting units 1, 2 may be made identical and contain public key generating blocks and the computers have both transmitting and receiving functions.

The synchronization of the system 100 may be performed in the beginning of usage. The synchronization may be carried out as follows: The sender and receiver simultaneously memorize the conditions of counters 8 and 13 in the memory cell of the micro-controllers of security key generators 9 and 14, respectively. For example, this could occur at every 6th peep during the checking time period of television or radio signals. The synchronization could be arranged automatically. For instance, 20 seconds after a registration of a user in a server computer. When generating the security key, this value may be subtracted from the output value of the counters 8, 13, respectively, to that the same pseudo-random values go in to both the generators 9 and 14. This is sufficient for generating the same security key at the receiving and the transmitting ends although that no security keys have been transmitted via the communication lines. In other words, the security key that is generated by the generator 9 is identical to the security key generated by the generator 14. The synchronization procedure may be performed although the master clocks may drift somewhat. However, the master clocks should be set and synchronized periodically, such as once a year. The synchronization may be performed automatically.

The security key at the transmitting side may be generated from two input parameters. One of the parameters is the public key and the other is the state of the counter 8 connected to the output of the master clock 7. Both parameters may be fed to the security key generator 9 to obtain the security key.

The existence of the master clock and the counter makes it possible to generate the new security key every time the public key is sent because the output condition of the counter 8 and the corresponding number on the input of the security key generator 9, connected with the output of the counter 4, change continuously with time.

The public key 16 and the security key 17a may enter the transmitting computer 4 where the encryption of the initial message 15 may be performed with the assistance of the keys 16, 17a. The public key 16 may be a number or a unique combination of characters and numbers. Subsequently, the public key 16 and the encrypted message 18 may move through the transmitting medium 3 and reach the receiving computer 10. At the receiving side, a security key 17b may be generated, in the same way as it was carried out at the transmitting side, by using the master clock 12, the counter 13, the security key generator 14 and the incoming public key 16 transmitted from the transmitting unit 1. After the generation of the security key 17b on the receiving side by security key generator 14, the message reaches the receiving computer 10 where the received message is decrypted with the help of the public key 16 and the security key 17b. An important feature is that the security key 17a is identical to the security key 17b as a result of the synchronization of the counters 8, 13. Obviously, the public 16 received by the computer 4 from the block 5 is the same as the public key 16 transmitted by the computer 4 to the computer 10 of the receiving unit 2. The decryption may be performed by the operation system of the receiving computer 10. Due to the fact that security keys on the transmitting and the receiving sides are identical, the message decrypting may be done without transferring the security key via the transmission medium 3.

The system 100 may operate according to the following steps:

1) Switch on the computers of the receiving and transmitting units;

2) If this is the first time any communication or message is sent from the transmitting unit to the receiving unit, perform the synchronization procedure;

3) Put in the initial message to the transmitting computer with the help of the keyboard or magnetic carrier of information;

4) Put in the public key (K) on the transmitting computer (see FIG. 2) with the help of the keyboard or the fingerprint scanner.

5) Send the public key via the transmission medium to the receiving unit;

6) Generate the security key in the transmitting computer by calling the program of pseudo-random number series generated from the read-only memory of the micro-controller of the security key generator 9, using the starting number (S) as the input value, obtained from public key (K) by the step of generating the security key;

7) Encrypt the message by means of the operation system of transmitting computer by using the security key obtained at the previous step and the public key (K) obtained in step 4;

8) Receive and store the public key in the receiving computer for further decrypting of the initial message;

9) Send the encrypted message via the transmission medium to the receiving computer;

10) Receive the encrypted message on the receiving computer;

11) Generate the security key in the receiving computer by calling the program of pseudo-random number series generated from the read-only memory of security key 14 generator micro-controller, using the starting number (S) as the input value, that is obtained from the public key (K), to generate the security key that is the same as the security key generate at the transmitting unit; and

12) Decrypt the message by means of the operation system of the receiving computer by using the security key obtained at the previous step and the public key (K) obtained in step 5.

The synchronization procedure may be carried out as follows. It is necessary to synchronize the transmitting unit and receiving unit before the first message is sent therebetween. During the first power-up of the system, the synchronization procedure for the blocks 6, 11 may, preferably, be performed on the receiving and transmitting computers. For this, the clock of systems' computers should be synchronized and the state of the counters 8 and 13 should be memorized at the same moment in the memory cell of micro-controller of security key generators 9 and 14 in the transmitting and receiving computers, respectively. This number may be used as the synchronization constant for steps 6) and 11) of the method of the function of the system.

The method and system of present invention have many advantages. The same starting numbers for Step 1) of the program of generating the security keys at the receiving and the transmitting operation devices are obtained by subtraction of each device's own synchronization constant that is obtained during above-mentioned procedure from the current value of the counters 8 and 13. The starting number (S) may be generated from the public key that is transmitted via the communication line 3. This explains why the starting value for starting the generation of pseudo-random number series on the receiving and transmitting devices will also be the same. Due to the fact that generators use the same method steps, their output values, i.e. security keys on receiving and transmitting devices, will also be the same.

The presented method and system of secret communication has the following advantages:

1) Due to the fact that the security key is not sent via transmitting medium, the implementation of the method and system of the present invention provides a qualitatively new degree of protection of the telematic information that completely excludes the possibility of accessing the security key and the loss or transfer of he security key a third party, whether voluntarily or by force; and

2) The use of the fingerprint scanner as the public key generating block allows to maximally simplify the procedure of user's access to secure resources. The public key in this case is also impossible to loose or pass over to a third party.

The system may be made as a standard board for IBM-compatible computers that provides the possibility of easy installation of the system in any stage of the computer assembly at the computer factor or by the user of the system. The installation of the software drivers of the operation of the system does not require special knowledge and can be done using floppy disk or CD included in the package. The use of the two keys, the public and security keys, provides compatibility with widely used message encrypting systems and provides the possibility of using encrypting means provided by the developer of computer operation system of receiving and transmitting units or by other companies. The system can be used in all cases where high reliability and security of transmitted information are required and especially in those cases when the Internet is the transmission medium. The system may be used by banks that work with a great number of clients and systems such as security persons, stock exchanges and trading systems and cellular telephone systems.

With reference to FIG. 2, a public key 200 may be sent to a starting number generating unit 202. The unit 202 may create a starting number (S) by using an equation 204 where the parameter (Nc) is a current number of the counters 8, 13, the parameter (M) is a synchronization constant that may be different for each computer and (K) is the public key. One important feature of the present invention is that the method 100 takes into account the difference between the current number of the counter and the synchronization constant so even though the synchronization constant may be different for each computer, the difference between the current number and the synchronization constant is the same since the master clocks 7 and 12 are synchronized. This means that the transmitting unit 1 and the receiving unit 2 will generate the same starting number at each time period in time. The starting number (S) is then used in a pseudo-random generator 206 to generate a pseudo-random number series as described by {A0, A1, A2 . . . AN}=X(S).

The generator 206 will generate the same number series over and over again when the same starting number (S) is used. The number series is then sent to a security key generating unit 208 that generates the security key (SK) as described by S-key=Y(A0, A1, A2 . . . AN). As indicated above, the counter 8 and the counter 13 produce the same starting number since the master clocks 7 and 12, connected to the counters 8 and 13, respectively, have been synchronized prior to the transmission of any messages 15 or public keys 16.

While the present invention has been described in accordance with preferred compositions and embodiments, it is to be understood that certain substitutions and alterations may be made thereto without departing from the spirit and scope of the following claims.

1. A method of secret communication between a transmitting unit and a receiving unit, comprising:
the transmitting unit generating a public key;
the transmitting unit generating a first security key;
encrypting a message to an encrypted message using the public key and the first security key;
sending the encrypted message and the public key, but not the first security key, to the receiving unit;
the receiving unit receiving the public key and the encrypted message;
the receiving unit generating a second security key, the second security key being identical to the first security key; and
the receiving unit decrypting the message to the message using the public key 16 and the second security key.

2. The method according to claim 1 wherein the method further comprises the transmitting unit generating a third security key after the generation of the first security key, the third security key being different from the first security key, the transmitting unit sending the message and the public key to the receiving unit, the receiving unit generating a fourth security key using the public key, the fourth security key being identical to the third security key.

3. The method according to claim 1 wherein the method further comprises the transmitting unit 1 using a first counter to generate the first security key.

4. The method according to claim 3 wherein the method further comprises the first counter being connected with a master clock.

5. The method according to claim 1 wherein the method further comprises generating the public key in a public key generating unit.

6. The method according to claim 5 wherein the method further comprises connecting the public key generating unit to a fingerprint scanner.

7. The method according to claim 3 wherein the method further comprises associating the counter with a synchronization constant (M) and a current counter number (Nc).

8. The method according to claim 7 wherein the method further comprises the transmitting unit memorizing a current number Nc of the counter, the receiving unit simultaneously memorizing a current number Nc of the counter and the transmitting unit 1 being connected to the receiving unit via a transmitting medium.

9. The method according to claim 1 wherein the method further comprises synchronizing the transmitting unit with the receiving unit before a first message is encrypted in the transmitting unit.
